(19) United States
(12) Patent Application Publication
(10) Pub. No.: US 2018/0246608 A1
(43) Pub. Date: Aug. 30, 2018

(54) DIGITIZER AND METHOD OF PREPARING THE SAME

(71) Applicant: DONGWOO FINE-CHEM CO., LTD., Iksan-si (KR)

(72) Inventors: Yoonho HUH, Seoul (KR); Seung Jin CHAE, Anyang-si (KR); Byung Jin CHOI, Incheon (KR)

(73) Assignee: DONGWOO FINE-CHEM CO., LTD., Iksan-si (KR)

(21) Appl. No.: 15/901,965

(22) Filed: Feb. 22, 2018

(30) Foreign Application Priority Data
Feb. 28, 2017 (KR) 10-2017-0026369

(51) Int. Cl. G06F 3/041; G06F 3/044

(52) U.S. Cl. CPC G06F 3/0412; G06F 3/044; G06F 2203/04102; G06F 2203/04103; G06F 2203/04111

(57) ABSTRACT

A digitizer in which a second electrode of the digitizer is formed in a non-patterned portion of a touch sensing electrode of a mutual-capacitive type touch sensor is provided. The digitizer according to the present invention has a high level of pressure sensing, a simplified manufacturing process, and excellent visibility.

### CROSS REFERENCE TO RELATED APPLICATIONS

This application claims priority based on Korean Patent Application No. 10-2017-0026369, filed Feb. 28, 2017, the content of which is incorporated herein by reference in its entirety.

### TECHNICAL FIELD

The present invention relates to a digitizer and a method of preparing the same. Particularly, the present invention relates to a digitizer that can be integrated with a touch sensor and a method of preparing the same.

### BACKGROUND ART

In recent display devices, a touch input method in which a user directly touches a screen using a finger or an electronic pen to input is widely used. As such a touch input method can be combined with a display screen without a separate input device such as a keyboard or a mouse, it is advantageously used for a portable terminal such as a smart phone, a notebook computer, and a tablet PC.

In general, a capacitive touch sensor in which a user performs input using a finger is advantageous in that it is intuitive and simple, but there is a limitation in specifying precise coordinates. Accordingly, a digitizer of an electro-magnetic resonance (EMR) method using a pen is advantageously used for precise graphic input.

As an attempt to integrate these two input methods into one device, Korean Patent Laid-Open Publication No. 2015-0135565 discloses a touch panel comprising a transparent substrate divided into an active region and a bezel region; a touch sensing part formed on the active region of the transparent substrate and sensing a capacitance change; an insulation film formed on the upper surface of the touch sensing part and having a mesh pattern; and a metal pattern part formed on the upper surface of the insulation film and including an electrode having a mesh pattern and capable of receiving a signal transmitted from the outside or transmitting a power signal to the outside.

However, in the touch panel disclosed in Korean Patent Laid-Open Publication No. 2015-0135565, since a signal transmitted from the outside is received or a power signal is transmitted to the outside using one metal pattern part, the sensitivity is low and there is a possibility that noise is generated. Further, there is a problem of visibility due to a difference in transmittance between a portion where the metal pattern is formed and a portion where the metal pattern is not formed since the metal pattern forms a loop pattern overlapping with the touch sensing part.

### DISCLOSURE OF INVENTION

### Technical Problem

It is an object of the present invention to provide a digitizer which can be formed integrally with a touch sensor and has a high level of pressure sensing and a method of preparing the same.

It is another object of the present invention to provide a digitizer which can be formed integrally with a touch sensor and whose manufacturing process is simplified and a method of preparing the same.

It is still another object of the present invention to provide a flexible display device including the digitizer.

### Technical Solution

According to an aspect of the present invention, there is provided a digitizer comprising: a substrate; a touch sensor disposed on the substrate; a first insulation layer formed on the touch sensor; a first digitizer electrode formed on the first insulation layer; a second insulation layer formed on the first digitizer electrode; a second digitizer electrode formed on the second insulation layer not to overlap with a pattern of the touch sensor; and a passivation layer formed on the second digitizer electrode.

Here, the touch sensor may be a mutual-capacitive type touch sensor and the touch sensor may comprise: a first and a second touch sensing electrodes disposed on the substrate; and a touch sensor bridge electrically insulated from the second touch sensing electrode and electrically connected to the first touch sensing electrode.

According to another aspect of the present invention, there is provided a digitizer comprising: a substrate; a first and a second touch sensing electrodes disposed on the substrate; a first insulation layer formed on the first and the second touch sensing electrodes and having a through hole exposing the first touch sensing electrode; a first digitizer electrode formed on the first insulation layer and a touch sensor bridge formed on the first insulation layer to be electrically connected to the first touch sensing electrode via the through hole; a second insulation layer formed on the first digitizer electrode and the touch sensor bridge; a second digitizer electrode formed on the second insulation layer not to overlap with the first and the second touch sensing electrodes; and a passivation layer formed on the second digitizer electrode.

In the above digitizers, the substrate may be a flexible substrate.

The second digitizer electrode may be made of a metal.

The second digitizer electrode may be formed in a direction of a short axis of the digitizer.

The second digitizer electrode may be formed to have two or more loops in a longitudinal direction.

According to yet another aspect of the present invention, there is provided a flexible display device comprising: the abode-described digitizer and a display layer disposed under the digitizer.

According to a further aspect of the present invention, there is provided a method of preparing a digitizer comprising the steps of: forming a touch sensor on a substrate; forming a first insulation layer on the touch sensor; forming a first digitizer electrode on the first insulation layer; forming a second insulation layer on the first digitizer electrode; forming a second digitizer electrode on the second insulation layer not to overlap with a pattern of the touch sensor; and forming a passivation layer on the second digitizer electrode.

According to another method of preparing a digitizer of an aspect of the present invention, the method comprises the steps of: forming a first and a second touch sensing electrodes on a substrate; forming a first insulation layer having a through hole exposing the first touch sensing electrode on the first and the second touch sensing electrodes; forming a first digitizer electrode and a touch sensor bridge electrically connected to the first touch sensing electrode via the through hole on the first insulation layer; forming a second insulation layer on the first digitizer electrode and the touch sensor bridge; forming a second digitizer electrode on the second insulation layer not to overlap with the first and the second touch sensing electrodes; and forming a passivation layer on the second digitizer electrode.

### Advantageous Effects

The digitizer according to the present invention has a high level of pressure detection, a simplified manufacturing process, and excellent visibility.

### DESCRIPTION OF DRAWINGS

FIG. 1 is a plan view schematically illustrating a touch sensor integrated digitizer according to an embodiment of the present invention.

FIG. 2 is a cross-sectional view taken along the line II-II′ of FIG. 1.

FIG. 3 is a plan view schematically illustrating a touch sensor integrated digitizer according to another embodiment of the present invention.

FIG. 4 is a cross-sectional view taken along the line IV-IV′ of FIG. 3.

FIG. 5 is a plan view schematically illustrating a touch sensor integrated digitizer according to yet another embodiment of the present invention.

### BEST MODE

Hereinafter, the present invention will be described in detail with reference to the accompanying drawings. However, the drawings accompanying the present disclosure are mere examples for describing the present invention, and the present invention is not limited by the drawings. Also, some elements may be exaggerated, scaled-down, or omitted in the drawings for clearer expressions.

The present invention provides a digitizer and a method of preparing the same in which a digitizer is formed integrally with a mutual-capacitive type touch sensor and it has a simplified manufacturing process while having a high level of pressure sensing.

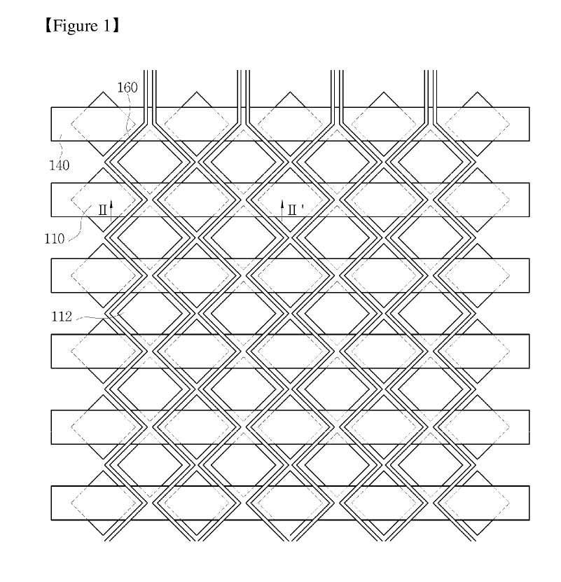

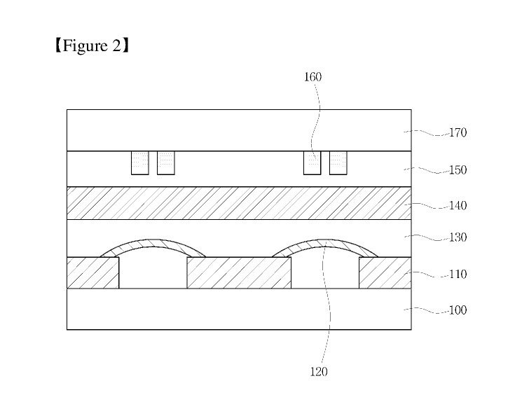

FIG. 1 is a plan view schematically illustrating a touch sensor integrated digitizer according to an embodiment of the present invention, and FIG. 2 is a cross-sectional view taken along the line II-II′ of FIG. 1.

Referring FIGS. 1 and 2, a touch sensor integrated digitizer according to an embodiment of the present invention includes a first and a second touch sensing electrodes 110 and 112 for sensing a touch and a touch sensor bridge 120 for electrically connecting the first touch sensing electrodes 110.

The touch sensor included in the touch sensor integrated digitizer according to an embodiment of the present invention is a mutual-capacitive type touch sensor that senses a change of capacitance generated between the first and second touch sensing electrodes (also referred to as a sensing electrode and a driving electrode) due to a finger touch. The structure is complicated as compared with a self-capacitive type touch sensor that sets the capacitance of the touch sensing electrode itself as an initial value and recognizes a change in capacitance occurring in the touch sensing electrode as it is touched by a finger. However, many mobile touch screen panels adopt the mutual-capacitive type because it is possible to realize multi-touch and implement accurate linearity.

Accordingly, in the embodiment of the present invention as shown in FIGS. 1 and 2, the first and second touch sensing electrodes 110 and 112 are formed on the substrate 100, and the first touch sensing electrodes 110 are connected to each other through the touch sensor bridge 120.

Materials and shapes of the first and second touch sensing electrodes 110 and 112 and the touch sensor bridge 120 may be any of materials and shapes used in general touch sensors, and are not particularly limited in the present invention.

For example, the first and second touch sensing electrodes 110 and 112 and the touch sensor bridge 120 may be formed of a transparent conductive film material, and may be formed of at least one selected from metal, metal mesh, metal nanowire, metal oxide, carbon nanotube, graphene, conductive polymer, and conductive ink.

Here, the metal may be any one of gold, silver, copper, nickel, chromium, molybdenum, aluminum, palladium, neodymium, platinum, zinc, tin, titanium and alloys thereof.

The metal nanowire can be any one of silver nanowire, copper nanowire, zirconium nanowire, and gold nanowire.

The metal oxide may be selected from the group consisting of indium tin oxide (ITO), indium zinc oxide (IZO), indium zinc tin oxide (IZTO), aluminum zinc oxide (AZO), gallium zinc oxide (GZO), fluorine tin oxide (FTO) and zinc oxide (ZnO).

Also, the first and second touch sensing electrodes 110 and 112 and the touch sensor bridge 120 may be formed of a carbon-based material including carbon nanotube (CNT) and graphene.

The conductive polymer may include polypyrrole, polythiophene, polyacetylene, PEDOT, or polyaniline. The conductive ink includes a mixture of a metal powder and a curable polymeric binder.

In addition, the first and second touch sensing electrodes 110 and 112 and the touch sensor bridge 120 may have a stacked structure of two or more conductive layers in order to reduce electrical resistance.

As an embodiment, the first and second touch sensing electrodes 110 and 112 and the touch sensor bridge 120 may be formed as a single layer of ITO, AgNW (silver nanowire), or metal mesh. In the case of forming two or more layers, the first electrode layer may be formed of a transparent metal oxide such as ITO, and the second electrode layer may be formed on the ITO electrode layer using metal, AgNW, or the like to further reduce the electrical resistance.

The first and second touch sensing electrodes 110 and 112 are formed on the substrate 100.

In an embodiment of the present invention, the substrate 100 may be a flexible film substrate, especially a transparent film.

The transparent film is not limited if it has good transparency, mechanical strength and thermal stability. Specific examples of the transparent film may include thermoplastic resins, e.g., polyester resins such as polyethylene terephthalate, polyethylene isophthalate, polyethylene naphthalate and polybutylene terephthalate; cellulose resins such as diacetylcellulose and triacetylcellulose; polycarbonate resins; acrylate resins such as polymethyl (meth)acrylate and polyethyl (meth)acrylate; styrene resins such as polystyrene and acrylonitrile-styrene copolymer; polyolefin resins such as polyethylene, polypropylene, polyolefin having a cyclic or norbornene structure, and ethylene-propylene copolymer; vinyl chloride resins; amide resins such as nylon and aromatic polyamide; imide resins; polyethersulfone resins; sulfone resins; polyether ether ketone resins; polyphenylene sulfide resins; vinyl alcohol resins; vinylidene chloride resins; vinyl butyral resins; allylate resins; polyoxymethylene resins; and epoxy resins. Also, a film consisting of a blend of the thermoplastic resins may be used. In addition, thermally curable or UV curable resins such as (meth)acrylate, urethane, acrylic urethane, epoxy and silicon resins may be used.

Such a transparent film may have a suitable thickness. For example, considering workability in terms of strength and handling, and thin layer property, the thickness of the transparent film may range from 1 to 500 μm, preferably 1 to 300 μm, more preferably 5 to 200 μm.

The transparent film may contain at least one suitable additive. Examples of the additive may include an UV absorber, an antioxidant, a lubricant, a plasticizer, a releasing agent, a coloring-preventing agent, an anti-flame agent, an anti-static agent, a pigment and a colorant. The transparent film may comprise various functional layers including a hard coating layer, an anti-reflective layer and a gas barrier layer, but the present invention is not limited thereto. That is, other functional layers may also be included depending on the desired use.

If necessary, the transparent film may be surface-treated. For example, the surface treatment may be carried out by drying method such as plasma, corona and primer treatment, or by chemical method such as alkali treatment including saponification.

Also, the transparent film may be an isotropic film, a retardation film or a protective film.

In the case of the isotropic film, it is preferred to satisfy an in-plane retardation (Ro) of 40 nm or less, preferably 15 nm or less and a thickness retardation (Rth) of −90 nm to +75 nm, preferably −80 nm to +60 nm, particularly −70 nm to +45 nm, the in-plane retardation (Ro) and thickness retardation (Rth) being represented by the following equations.

Ro=[(nx−ny)*d]

Rth=[(nx+ny)/2−nz]*d

wherein, nx and ny are each a main refractive index in a film plane, nz is a refractive index in the thickness direction of film, and d is a thickness of film.

The retardation film may be prepared by uniaxial stretching or biaxial stretching of a polymer film, coating of a polymer or coating of a liquid crystal, and it is generally used for improvement or control of optical properties, e.g., viewing angle compensation, color sensitivity improvement, light leakage prevention, or color control of a display.

The retardation film may include a half-wave (½) or quarter-wave (¼) plate, a positive C-plate, a negative C-plate, a positive A-plate, a negative A-plate, and a biaxial plate.

The protective film may be a polymer resin film comprising a pressure-sensitive adhesive (PSA) layer on at least one surface thereof, or a self-adhesive film such as polypropylene, which may be used for protection of the digitizer surface or improvement of processability.

A first digitizer electrode 140 is formed on the insulation layer 130 covering the first and second touch sensing electrodes 110 and 112 and the touch sensor bridge 120 in the form of a horizontal band.

In one embodiment of the present invention, the first digitizer electrode 140 is used as a receiver part of the digitizer.

According to the present invention, a transmitter electrode for transmitting a signal in the digitizer and a receiver electrode for receiving a signal are separately formed to suppress noise due to mutual interference and improve the detection resolution.

The material and shape of the first digitizer electrode 140 may be any of the materials and shapes used in general digitizers, and are not particularly limited in the present invention.

For example, the first digitizer electrode 140 may be formed using the same material as that used to form the first and second touch sensing electrodes 110 and 112 and the touch sensor bridge 120.

An insulation layer 150 is formed on the first digitizer electrode 140.

The insulation layer 150 may be formed of an organic insulation layer or an inorganic insulation layer.

A second digitizer electrode 160 is formed on the insulation layer 150 along a portion where the patterns of the first and second touch sensing electrodes 110 and 112 are not formed.

The second digitizer electrode 160 is an electrode used as a transmitter part of the digitizer in an embodiment of the present invention, and is preferably made of a metal to achieve a low resistance. For the sake of visibility, it may be formed in a rhombic continuous loop shape along the non-patterned portion of the touch sensing electrodes 110 and 112 so as not to overlap with the first and second touch sensing electrodes 110 and 112.

Examples of the metal material constituting the second digitizer electrode 160 include gold (Au), silver (Ag), copper (Cu), molybdenum (Mo), nickel (Ni), chromium (Cr), silver-palladium-copper alloy (Ag/Pd/Cu, APC), without limitation.

In the embodiment of the present invention shown in FIGS. 1 and 2, the first digitizer electrode 140 used as a receiver part is formed in a lateral direction in a lower part of the digitizer, and the second digitizer electrode 160 used as a transmitter part is formed in a longitudinal direction in an upper part of the digitizer. However, the positions and directions of the first and second digitizer electrodes are not limited thereto.

However, the structure described above may be preferable because the second digitizer electrode 160 of the digitizer is closer to the pen, which is advantageous for sensing the pressure.

A passivation layer 170 is formed on the second digitizer electrode 160.

The passivation layer may be formed of, for example, a polycycloolefin-based material, and may have a thickness of 0.5 to 5 μm.

Meanwhile, the manufacturing process can be simplified by forming the touch sensor bridge and the first digitizer electrode so as not to overlap with each other.

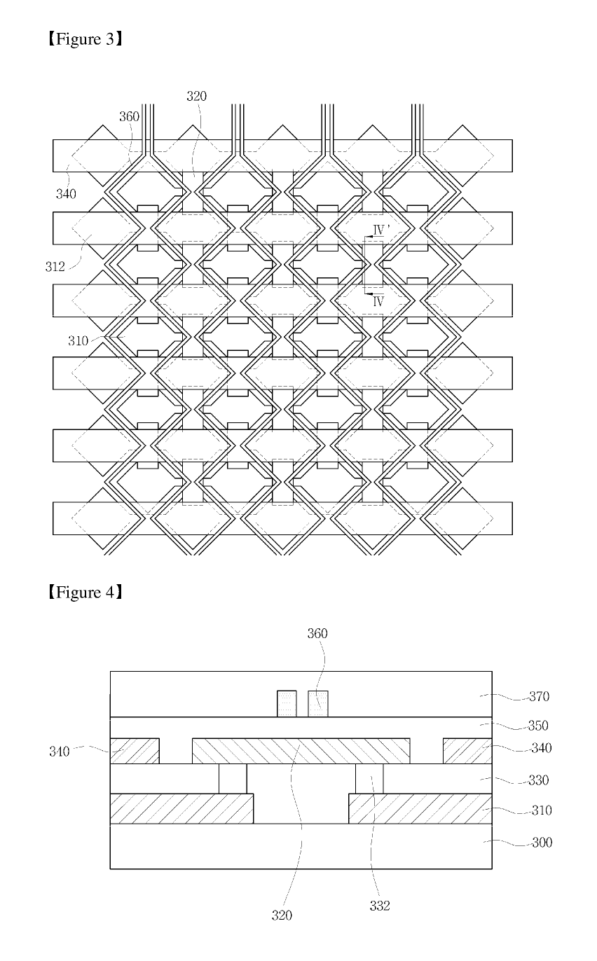

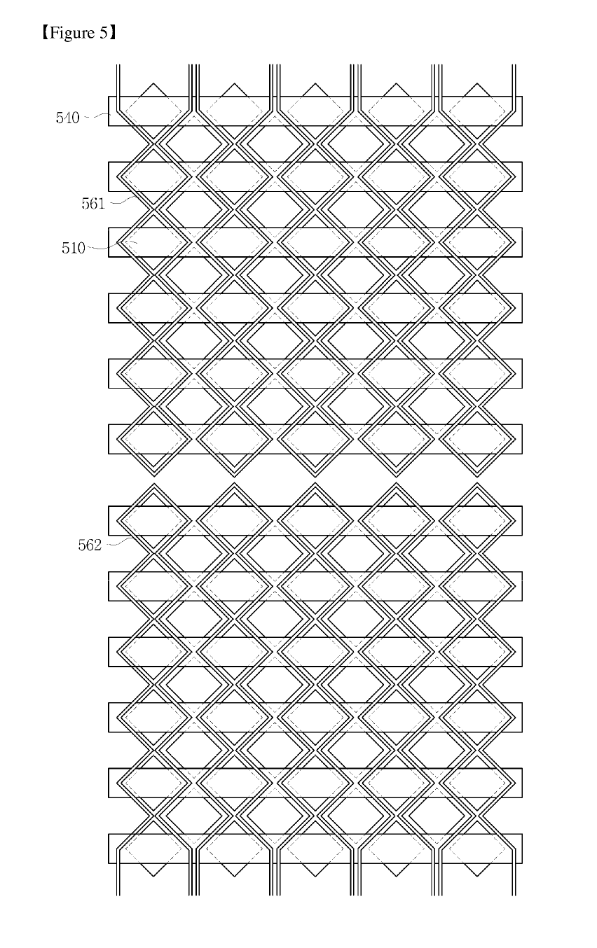

FIG. 3 is a plan view schematically illustrating a touch sensor integrated digitizer according to another embodiment of the present invention, and FIG. 4 is a cross-sectional view taken along the line IV-IV′ of FIG. 3.

As shown in FIGS. 3 and 4, a first touch sensing electrode 310 and a second touch sensing electrode 312 are formed on the substrate 300 and an insulation layer 330 is formed thereon.

A through hole 332 for exposing the first touch sensing electrode 310 is formed in the insulation layer 330 so that the touch sensor bridge 320 formed on the insulation layer 330 electrically connects the first touch sensing electrodes 310 via the through hole 332.

The first digitizer electrode 340 is formed in the same layer as the touch sensor bridge 320 on the insulation layer 330.

An insulation layer 350 is formed again on the touch sensor bridge 320 and the first digitizer electrode 340, and a second digitizer electrode 360 is formed on the insulation layer 350.

As described above with reference to FIGS. 1 and 2, the second digitizer electrode 360 is formed of a metal in the non-patterned portion so as not to overlap with the touch sensing electrodes 310 and 312.

A passivation layer 370 is formed on the second digitizer electrode 360.

As the length of the electrode loop forming the transmitter part of the digitizer is shorter, the level of the pressure sensing increases. In this regard, the shape of the electrode loop can be variously modified. For example, the second digitizer electrode loop may be divided into two portions to form two loops, respectively.

FIG. 5 is a plan view of a touch sensor integrated digitizer according to another embodiment of the present invention in which an electrode loop of a transmitter part is divided into two portions.

According to another embodiment of the present invention, the touch sensing electrode 510 and the first digitizer electrode 540 are formed to be insulated from each other on a substrate (not shown), and the second digitizer electrodes 561 and 562 are formed to be insulated from the touch sensing electrode 510 and the first digitizer electrode 540.

The remaining components except for the second digitizer electrodes 561 and 562 are similar to those of the embodiment of the present invention described with reference to FIGS. 1 and 2, so a detailed description thereof will be omitted.

Referring to FIG. 5, in another embodiment of the present invention, the second digitizer electrodes 561 and 562 are configured so as to form two electrode loops in a longitudinal direction. This is to reduce the length of the electrode loop of the transmitter part and increasing the number of loops, which may be advantageous for increasing the power intensity of the transmitter part and enhancing the level and resolution of the pressure sensing.

Also, it may be advantageous to form the second digitizer electrode in the direction of a short axis in order to reduce the length of the electrode loop of the transmitter part.

According to another aspect of the present invention, there is provided a flexible display device including the digitizer as described above.

The flexible display device according to the present invention may include a digitizer according to any one of the embodiments of the present invention shown in FIGS. 1 to 5 and a display layer disposed under the digitizer.

Now, a method for preparing a touch sensor integrated digitizer according to an embodiment of the present invention will be described in detail.

The touch sensor integrated digitizer of the present invention may be formed directly on a substrate. Or, it may be prepared using a carrier substrate to form a touch sensor integrated digitizer, and then the carrier substrate may be separated and a substrate film may be attached.

In this specification, a method of forming a digitizer directly on a substrate will be mainly described.

First, a transparent conductive film is formed on a substrate and patterned to form a first and a second touch sensing electrodes. The patterning of the transparent conductive film can be performed through a photolithography process using a photosensitive resist.

The transparent conductive film may be formed by a sputtering process such as CVD (Chemical Vapor Deposition), PVD (Physical Vapor Deposition), PECVD (Plasma Enhanced Chemical Vapor Deposition), a printing process such as screen printing, gravure printing, reverse offset, inkjet, or dry or wet plating process. In the case of depositing by a sputtering process, a mask having a desired electrode pattern shape is disposed on a substrate and a sputtering process is performed to form an electrode pattern layer. Alternatively, a conductive layer may be formed on the entire surface by the above-described film forming method, and an electrode pattern layer may be formed by using a photolithography process.

The photosensitive resist may be a negative type photosensitive resist or a positive type photosensitive resist.

Next, a touch sensor bridge, which is insulated from the second touch sensing electrode and connects the first touch sensor electrodes, is formed, and an insulation layer is formed to cover the first and second touch sensor electrodes and the touch sensor bridge.

As the method of applying the insulation layer, a known coating method may be used. For example, spin coating, die coating, spray coating, roll coating, screen coating, slit coating, dip coating, gravure coating and the like can be used.

Next, a transparent conductive film is formed on the insulation layer and patterned to form a first digitizer electrode.

The transparent conductive film pattern of the first digitizer electrode may be formed through a process similar to that of forming the first and second touch sensing electrode patterns.

Now, an insulation layer covering the first digitizer electrode is formed again, and a metal material is patterned thereon to form a second digitizer electrode. The metal layer may be deposited by a process such as CVD, PVD and PECVD, but is not limited thereto.

Next, a passivation layer is formed on the entire surface of the second digitizer electrode.

On the other hand, in order to overcome process difficulties that occur when a flexible substrate is used, a process may be performed using a carrier substrate, and the digitizer may be transferred on a flexible film substrate to implement a flexible digitizer.

In this case, a common process using a carrier substrate can be used without any particular limitation, and a detailed description thereof will be omitted. However, it will be easily deduced by a person skilled in the art based on the above-described process of forming on a flexible substrate.

Although particular embodiments and examples of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

### DESCRIPTION OF REFERENCE NUMERALS

100, 300: substrate
110, 112, 310, 312, 510: touch sensing electrode
120, 320: touch sensor bridge
130, 330, 150, 350: insulation layer
332: through hole
140, 340, 540: first digitizer electrode
160, 360, 561, 562: second digitizer electrode
170, 370: passivation layer

1. A digitizer comprising:
a substrate;
a touch sensor disposed on the substrate;
a first insulation layer formed on the touch sensor;
a first digitizer electrode formed on the first insulation layer;
a second insulation layer formed on the first digitizer electrode;
a second digitizer electrode formed on the second insulation layer not to overlap with a pattern of the touch sensor; and
a passivation layer formed on the second digitizer electrode.

2. The digitizer of claim 1, wherein the touch sensor is a mutual-capacitive type touch sensor and the touch sensor comprises:
a first and a second touch sensing electrodes disposed on the substrate; and
a touch sensor bridge electrically insulated from the second touch sensing electrode and electrically connected to the first touch sensing electrode.

3. A digitizer comprising:
a substrate;
a first and a second touch sensing electrodes disposed on the substrate;
a first insulation layer formed on the first and the second touch sensing electrodes and having a through hole exposing the first touch sensing electrode;
a first digitizer electrode formed on the first insulation layer and a touch sensor bridge formed on the first insulation layer to be electrically connected to the first touch sensing electrode via the through hole;
a second insulation layer formed on the first digitizer electrode and the touch sensor bridge;
a second digitizer electrode formed on the second insulation layer not to overlap with the first and the second touch sensing electrodes; and
a passivation layer formed on the second digitizer electrode.

4. The digitizer of claim 1, wherein the substrate is a flexible substrate.

5. The digitizer of claim 1, wherein the second digitizer electrode is made of a metal.

6. The digitizer of claim 1, wherein the second digitizer electrode is formed in a direction of a short axis of the digitizer.

7. The digitizer of claim 1, wherein the second digitizer electrode is formed to have two or more loops in a longitudinal direction.

8. A display device comprising:
a digitizer according to claim 1; and
a display layer disposed under the digitizer.

9. A method of preparing a digitizer comprising the steps of:
forming a touch sensor on a substrate;
forming a first insulation layer on the touch sensor;
forming a first digitizer electrode on the first insulation layer;
forming a second insulation layer on the first digitizer electrode;
forming a second digitizer electrode on the second insulation layer not to overlap with a pattern of the touch sensor; and
forming a passivation layer on the second digitizer electrode.

10. A method of preparing a digitizer comprising the steps of:
forming a first and a second touch sensing electrodes on a substrate;
forming a first insulation layer having a through hole exposing the first touch sensing electrode on the first and the second touch sensing electrodes;
forming a first digitizer electrode and a touch sensor bridge electrically connected to the first touch sensing electrode via the through hole on the first insulation layer;
forming a second insulation layer on the first digitizer electrode and the touch sensor bridge;
forming a second digitizer electrode on the second insulation layer not to overlap with the first and the second touch sensing electrodes; and
forming a passivation layer on the second digitizer electrode.

11. The method of claim 9, wherein the substrate is a flexible substrate.

12. The method of claim 9, wherein the second digitizer electrode is formed of a metal.

13. The method of claim 9, wherein the second digitizer electrode is formed in a direction of a short axis of the digitizer.

14. The method of claim 9, wherein the second digitizer electrode is formed to have two or more loops in a longitudinal direction.

15. The digitizer of claim 3, wherein the substrate is a flexible substrate.

16. The digitizer of claim 3, wherein the second digitizer electrode is made of a metal.

17. The digitizer of claim 3, wherein the second digitizer electrode is formed to have two or more loops in a longitudinal direction.

18. A display device comprising:
a digitizer according to claim 3; and
a display layer disposed under the digitizer.

19. The method of claim 10, wherein the substrate is a flexible substrate.

20. The method of claim 10, wherein the second digitizer electrode is formed of a metal.
